(19) United States
(12) Patent Application Publication
(10) Pub. No.: US 2005/0244261 A1
(43) Pub. Date: Nov. 3, 2005

(54) Apparatus for rotating and positioning a substrate-carrying cassette

(75) Inventor: Kuo-Feng Ting, Gueishan Township (TW)

Correspondence Address: BACON & THOMAS, PLLC, 625 SLATERS LANE, FOURTH FLOOR, ALEXANDRIA, VA, 22314, US

(73) Assignee: Quanta Display Inc., Tao Yuan Shien (TW)

(21) Appl. No.: 11/113,040

(22) Filed: Apr. 25, 2005

(30) Foreign Application Priority Data
Apr. 26, 2004 (TW) 093111653

(51) Int. Cl. B25J 1/00

(52) U.S. Cl. 414/758

(57) ABSTRACT

An apparatus for overturning and positioning a cassette is disclosed in the present invention so as to overturn a cassette and position the cassette after overturn. The apparatus for overturning and positioning a cassette comprises a overturning unit mounted on one side of the cassette to overturn the cassette, and at least one movable positioning unit including a base, a positioning member and a rolling member, the movable positioning unit being mounted on one side of the cassette being overturned. The positioning member and the rolling member are mounted on the base. The rolling member projects between the positioning member and the cassette so as to position the overturned cassette in a vertical direction while the positioning member positions the overturned cassette in a horizontal direction.

### BACKGROUND OF THE INVENTION

1. Field of the Invention

The present invention relates to an apparatus for overturning and positioning a cassette; in particular, the present invention relates to an apparatus for overturning and positioning a cassette adapted for loading large-sized substrates.

2. Description of Related Art

At present, a fab for fabricating display panels or wafers generally adopts cassettes for temporarily storing substrates. For example, as commonly seen in production lines, the substrates are stored in batches within a cassette at the initial stage, the cassette having an upward facing opening so as to prevent the substrates from being dropped. When the substrates in such batches are moved for a predetermined processing step, the operator places the cassette into a overturning device so that the cassette is turned to make the opening face sideward for facilitating transportation of the substrates into a chamber for the processing step by means of a transporting member (e.g. a robot). After this processing step is completed, the substrates will be taken out in order with the transporting member of the machine so as to be inserted into the cassette.

As such, the operation of taking out or inserting the substrates is performed frequently. However, the distance between the substrates is reduced as both the size of the substrate and the number of the substrates stacked within a single cassette increase. Thus, a precise alignment is required for the overturning operation of the cassette; namely, the cassette and the transporting member of the machine need to be precisely aligned to avoid damage to the substrates as a result of a collision of the substrates with the transporting member or the cassette. In practice, the cassette and the transporting member of the machine are respectively positioned so as to align with each other. In general, the transporting member is installed in the machine, being always monitored and controlled by the machine. Thus, it is easy to position the transporting member. However, the cassette is used to convey the substrates to be delivered to different machines for every processing step. It is therefore necessary to precisely position the cassette after every overturn with the overturning device. Accordingly, each substrate is able to be taken out or inserted within a tiny space (about 1 to 2 mm) between the substrates stored within the cassette by means of the transporting member without causing any damage to the substrates.

Referring to FIG. 1, a conventional overturning device is disclosed. A servomotor 100 is used to overturn a cassette 200. After overturn, a positioning block 300 moves toward the cassette 200 to hold the cassette 200 in a horizontal direction. Although the servo motor 100 is equipped with a loop circuit controller, significant inertia caused by the cassette of several kilograms and an acceleration caused by the overturn force restrain the cassette from being taken from its position within a short period of time. In addition, a buffer 410 is installed on an alignment platform 400 to provide a damping effect for buffering the impact force caused by the overturn of the cassette, as shown in FIG. 2.

Though the impact force so close to the alignment platform 400 after the cassette 200 is overturned with the servo motor 100 has been cushioned, the cassette 200 being overturned is restrained from being precisely positioned when the buffer 410 is shot or the spring-back-force becomes insufficient after a long term usage, as the positioning block 300 detains the cassette 200 before the cassette 200 is overturned to sit at a predetermined position. As such, a support seat 12 of the cassette 200 cannot contact fully with a locater 42, leaving a gap x between the support seat 12 and the locater 42. If the substrate is taken out of or inserted into the cassette 200, it will cause the substrate to be seriously fractured under such circumstances.

Furthermore, the conventional overturning and positioning device is capable of effecting only the horizontal position. Misalignment of the cassette in the vertical direction is frequently caused by particles on the edge of the cassette or uneven edging damage of the cassette. Although such a misalignment is not so critical for the small-sized panels, it needs to be solved for the present large-sized panels stacked in a high-density manner within the cassette.

Therefore, it is desirable to provide an improved apparatus for overturning and positioning a cassette to mitigate and/or obviate the aforementioned problems.

### SUMMARY OF THE INVENTION

A primary object of the present invention is to provide an apparatus for overturning and positioning a cassette so as to well position a cassette being overturned and prevent a substrate from being fractured.

To attain the aforesaid object, an apparatus for overturning and positioning a cassette according to the present invention is used to overturn a cassette and then position the cassette after overturn.

The apparatus for overturning and positioning a cassette comprises a overturning unit mounted on one side of the cassette to overturn the cassette, and at least one movable positioning unit including a base, a positioning member and a rolling member, the movable positioning unit being mounted on one side of the cassette being overturned. The positioning member and the rolling member are mounted on the base. The rolling member projects between the positioning member and the cassette so as to position the overturned cassette in a vertical direction while the positioning member positions the overturned cassette in a horizontal direction. Accordingly, the movable positioning unit moves toward the cassette when the cassette is overturned by means of the overturning unit and then positions the overturned cassette.

In the apparatus for overturning and positioning a cassette of the present invention, the positioning member is any usable positioning block, and the rolling member can be any usable rolling member, preferably a roller, and more preferably a precision ball bearing or a needle bearing. In the present invention, the overturning unit can be driven with any usable means, preferably a cylinder or a servomotor.

In a preferred embodiment of the present invention, the surface of the cassette in contact with the rolling member is preferably an oblique face to facilitate the rolling member to exert a downward force against the cassette and avoid the excessive wearing-out of the rolling member. The rolling member is preferably connected to the positioning member by means of an elastic member to buffer the counter force exerted upon the rolling member and to extend the life of usage of the rolling member. The elastic member can be any usable elastomer, preferably a spring. A rolling radius of the rolling member is preferably in the range of 2 and 15 mm to increase the scope of guiding the rolling member with respect to the cassette.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a conventional apparatus for overturning and positioning a cassette.

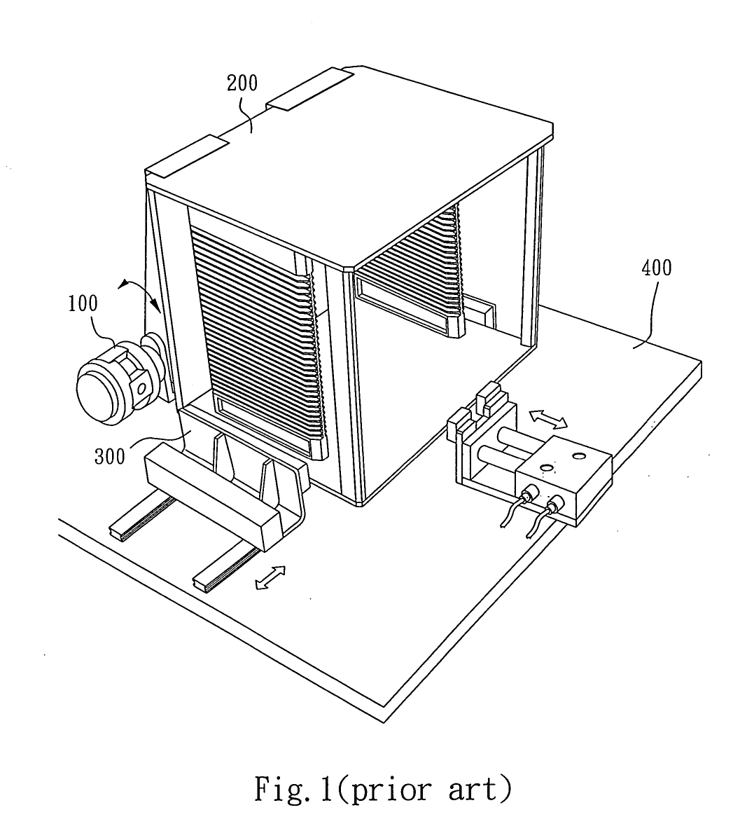

FIG. 2 is a schematic view of a conventional movable positioning unit for holding a cassette.

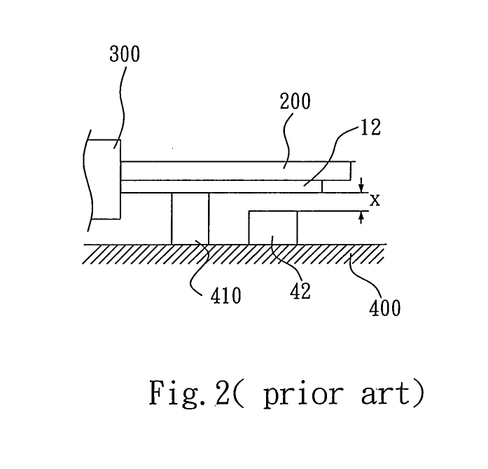

FIG. 3 is a perspective view of the apparatus for overturning and positioning a cassette according to a preferred embodiment of the present invention.

FIGS. 4a and 4b are flowcharts illustrating movements of a movable positioning unit for holding a cassette according to a preferred embodiment of the present invention.

FIG. 5a is an exploded perspective view of the apparatus for overturning and positioning a cassette according to another preferred embodiment of the present invention.

FIGS. 5b and 5c are flowcharts illustrating movements of a movable positioning unit for holding a cassette according to another preferred embodiment of the present invention.

### DETAILED DESCRIPTION OF THE PREFERRED EMBODIMENT

Preferred embodiments of the apparatus for overturning and positioning a cassette are illustrated with reference to the accompanying drawings.

### Embodiment 1

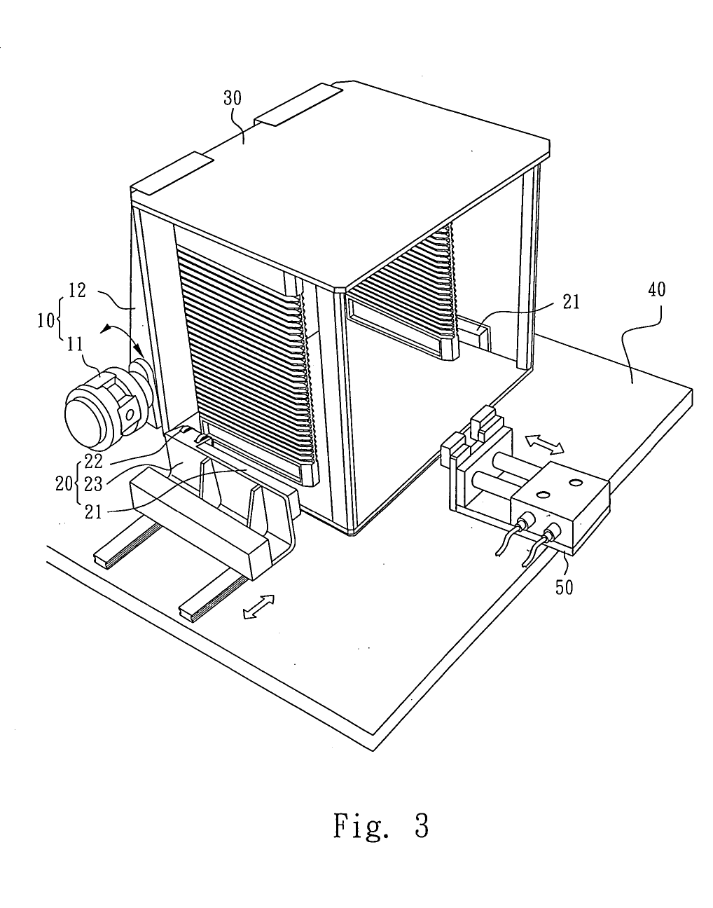

Referring now to FIG. 3, a perspective view of the apparatus for overturning and positioning a cassette according to a preferred of embodiment the present invention is shown. The apparatus for overturning and positioning a cassette of the present invention comprises a overturning unit 10 and a movable positioning unit 20. In this preferred embodiment, the overturning unit 10 is mounted on the bottom of the cassette to be overturned. The overturning unit 10 comprises an axle linking member 11 driven by a servo motor and an L-shaped support seat 12. The support seat 12 is actuated by the axle linking member 11 to cause overturn with respect to an alignment platform 40 so that the surface of the support seat 12 parallel to the alignment platform 40 is turned to be perpendicular to the alignment platform 40 while the surface of the support seat 12 perpendicular to the alignment platform 40 is turned to be parallel to the alignment platform 40.

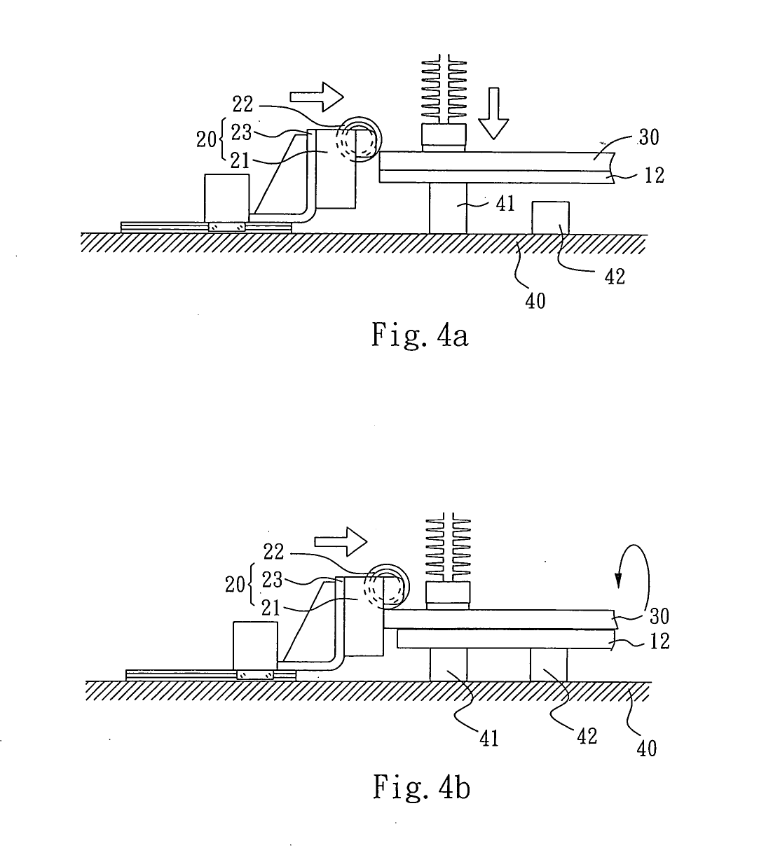

The support seat 12 is capable of holding the cassette to prevent the cassette 30 from being dropped during overturn. The movable positioning unit 20 is mounted on both sides of the cassette 30 being overturned, having a base 23, a positioning member 21 and a rolling member 22, in which both the rolling member 22 and the positioning member 21 are mounted on the base 23 and the rolling member 22 projects between the positioning member 21 and the cassette 30. When the cassette 30 is overturned with the overturning unit 10, the movable positioning unit 20 moves toward the cassette 30. As shown in FIG. 4a, the cassette 30 moves downward so that the rolling member 22 exerts a pressure against the cassette 30 in a vertical direction when the rolling member 22 contacts with the cassette 30. As shown in FIG. 4b, the cassette 30 is directed to an alignment position in the vertical direction, and also, the movable positioning unit 20 continues to move so as to guide the cassette 30 to an alignment position in a horizontal direction by means of the positioning member 21. Consequently, the cassette 30 is positioned. In this preferred embodiment, the positioning member 21 is a positioning block, and also, the rolling member 22 is a precise bearing (such as a ball bearing or a roller bearing) or a roller having a rolling radius in the range of 2 and 15 mm. In addition, in this preferred embodiment, a buffer 41 is pre-mounted below the cassette 30 being overturned to cushion the impact force exerted by the cassette 30 being overturned against the alignment platform 40. Alternatively, a locater 42 for pre-determining the position of the cassette 30 being overturned is mounted. This preferred embodiment may further comprise a sensor (not shown) for detecting whether the cassette 30 being overturned takes its position. In addition, the sensor may be further connected to the overturning unit 10, the movable positioning unit 20 and an auxiliary positioning unit 50 (as shown in FIG. 3). When the cassette 30 takes its position, the sensor transmits signals to the overturning unit 10, the movable positioning unit 20 and the auxiliary positioning unit 50 so that both the overturning unit 10 and the movable positioning unit 20 stop and the auxiliary positioning unit 50 moves toward the cassette 30 to assist at the holding of the cassette 30.

### Embodiment 2

The present embodiment is constructed and acted similar substantially to embodiment 1, comprising a overturning unit and a movable positioning unit, in which the overturning unit constituted by an axle linking member driven by a servo motor and an L-shaped support seat is mounted on the bottom of the cassette to be overturned. The support seat is actuated by the axle linking member to cause overturn with respect to an alignment platform so that the surface of the support seat parallel to the alignment platform is turned to be perpendicular to the alignment platform while the surface of the support seat perpendicular to the alignment platform is turned to be parallel to the alignment platform.

The support seat is capable of holding the cassette to prevent the cassette from being dropped during overturn. The movable positioning unit is mounted on both sides of the cassette being overturned, having a base 61, a positioning member 64 and a rolling member 62, in which both the rolling member 62 and the positioning member 64 are mounted on the base 61 and the rolling member 62 projects between the positioning member 64 and the cassette 60. When the cassette 60 is overturned with the overturning unit, the movable positioning unit moves toward the cassette. At this time, the cassette moves downward so that the rolling member exerts a pressure against the cassette in a vertical direction when the rolling member contacts with the cassette. Thus, the cassette is directed to an alignment position in the vertical direction, and also, the movable positioning unit continues to move so as to guide the cassette 60 to an alignment position in a horizontal direction by means of the positioning member 64.

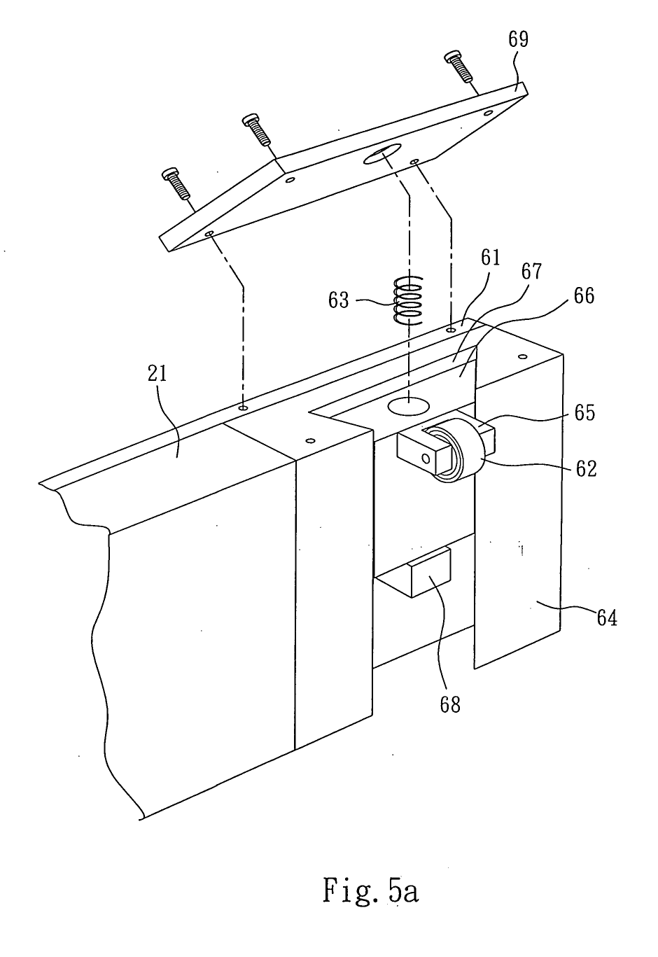

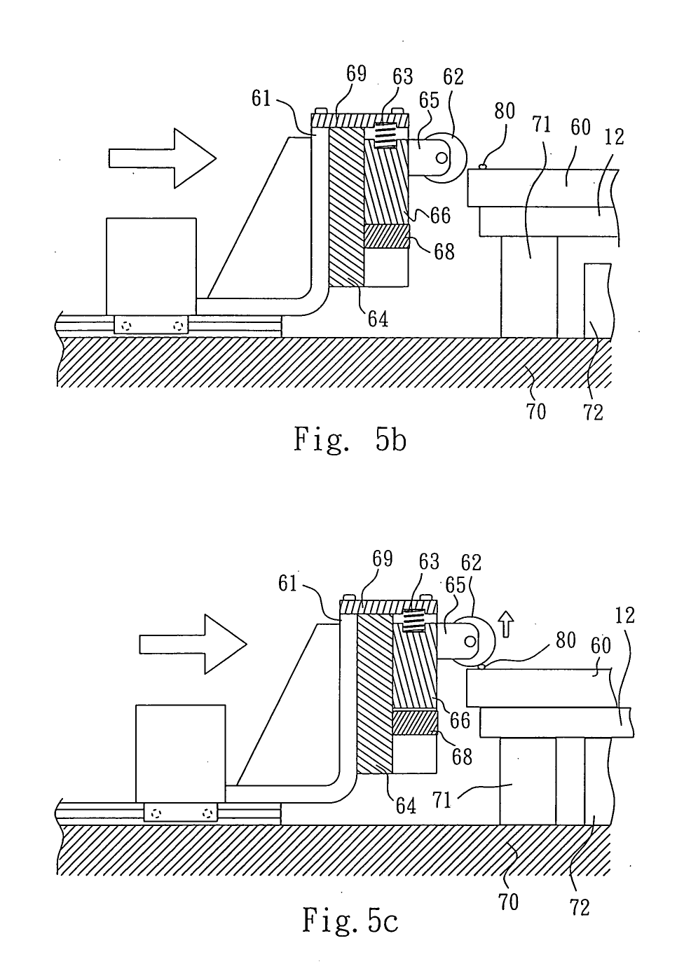

Consequently, the cassette 60 is positioned. As shown in FIG. 5a, the rolling member 62 is fixedly mounted on a fixed seat 65 fixedly mounted on a sliding block 66, as opposed to embodiment 1. The sliding block 66 is disposed in a sliding slot 67 to be moveable with respect to the sliding slot 67. A block 68 is mounted below the sliding block 66 to stop the sliding block 66. In addition, an elastic member 63 is sandwiched between a cap 69 and the sliding block 66. As shown in FIG. 5b, when the rolling member 62 is engaged with the cassette 60, the elastic member 63 can buffer the counter pressure exerted by the cassette 60 against the rolling member 62 to avoid an excessive pressure existing against the rolling member 62 so that the life of usage of the rolling member 62 is extended, as shown in FIG. 5c, even if miscellaneous articles, fractures or powder, such as particles 80, fall on the cassette 60. Further, the effect for buffering the counter pressure exerted by the cassette 60 against the rolling member 62 can be achieved by means of a cylinder. In this preferred embodiment, the rolling member 62 is a precision bearing (such as a ball bearing or a roller bearing) or a roller having a rolling radius in the range of 2 and 15 mm. Similarly, in this preferred embodiment, a buffer 71 is pre-mounted below the cassette 60 being overturned to cushion the impact force exerted by the cassette 60 being overturned against an alignment platform 70.

Alternatively, a locater 72 for pre-determining the position of the cassette being overturned is mounted. This preferred embodiment may further comprise a sensor (not shown) for detecting whether the cassette 60 being overturned takes its position. In addition, the sensor may be further connected to the overturning unit, the movable positioning unit and an auxiliary positioning unit. When the cassette takes its position, the sensor transmits signals to the overturning unit, the movable positioning unit and the auxiliary positioning unit so that both the overturning unit and the movable positioning unit stop and the auxiliary positioning unit moves toward the cassette 60 to assist at the holding of the cassette 60.

The thinner the substrate and the more the substrates loaded within every cassette, the narrower the gap between the substrates in the cassette. Thus, the requirement for a precise alignment of the cassette in loading or unloading the substrates becomes critical. The apparatus for overturning and positioning a cassette of the present invention adopts a simple and low-cost rolling device to bring on a highly precise positioning of the cassette after overturn of the cassette and further prevent a large quantity of the substrates from being fractured. The present invention provides great contributions toward reduction of the fabrication costs and increment of the yield.

Although the present invention has been explained in relation to its preferred embodiments, it is to be understood that many other possible modifications and variations can be made without departing from the spirit and scope of the invention as hereinafter claimed.

1. An apparatus for overturning and positioning a cassette adapted for overturning a cassette and positioning said cassette after overturn, comprising:
a overturning unit mounted on one side of said cassette to overturn said cassette; and
at least one movable positioning unit mounted on one side of said cassette being overturned, comprising a base, a positioning member and a rolling member, wherein said positioning member and said rolling member are mounted on said base, said rolling member projects between said positioning member and said cassette so as to position said overturned cassette in a vertical direction, and said positioning member positions said overturned cassette in a horizontal direction.

2. The apparatus of claim 1, wherein said positioning member is a positioning block.

3. The apparatus of claim 1, wherein said rolling member is a bearing or a roller.

4. The apparatus of claim 3, wherein said bearing is a ball bearing or a pillar bearing.

5. The apparatus of claim 1, wherein said overturning unit is driven by a cylinder or a servo motor.

6. The apparatus of claim 1, further comprising a sensor for detecting whether said overturned cassette is positioned.

7. The apparatus of claim 6, wherein said sensor is connected to said overturning unit and said movable positioning unit to be capable of transmitting signals to stop said overturning unit and said movable positioning unit when said overturned cassette is positioned.

8. The apparatus of claim 1, wherein an elastic member is disposed between said rolling member and said base to buffer the counter force exerted upon said rolling member.

9. The apparatus of claim 8, wherein said elastic member is a spring.

10. The apparatus of claim 1, wherein a cylinder is disposed between said rolling member and said base to buffer the counter force exerted upon said rolling member.

11. The apparatus of claim 1, wherein a rolling radius of said rolling member is in the range of 2 and 15 mm.
